(19) United States
(12) Patent Application Publication
(10) Pub. No.: US 2010/0163276 A1
(43) Pub. Date: Jul. 1, 2010

(54) SILVER-COATED MATERIAL FOR MOVABLE CONTACT COMPONENT AND METHOD FOR MANUFACTURING SUCH SILVER-COATED MATERIAL

(76) Inventors: Suguru Yamaguchi, Tokyo (JP); Yoshiaki Kobayashi, Tokyo (JP)

Correspondence Address: Kubotera & Associates, LLC, 200 Daingerfield Rd, Suite 202, Alexandria, VA, 22314, US

(21) Appl. No.: 12/593,028

(22) PCT Filed: Mar. 25, 2008
(86) PCT No.: PCT/JP2008/055604

§ 371 Date: Mar. 15, 2010

(30) Foreign Application Priority Data
Mar. 27, 2007 (JP) 2007-082604
Mar. 4, 2008 (JP) 2008-076885

(51) Int. Cl. H01B 1/02; B05D 5/12

(52) U.S. Cl. 174/126.2; 427/125

(57) ABSTRACT

A silver-coated material for a movable contact component is provided, in which a conductive base member (1) composed of iron or an iron alloy is coated with an underlayer (2) composed of nickel or a nickel alloy of 0.005 to 0.5 μm thick, the underlayer (2) is coated with an intermediate layer (3) composed of palladium, a palladium alloy or a silver tin alloy of 0.01 to 0.5 μm thick and the intermediate layer (3) is coated with an outermost surface layer (4) composed of silver or a silver alloy.

### TECHNICAL FIELD

The present invention relates to a silver-coated material for a movable contact component and to a method for manufacturing the silver-coated material.

### BACKGROUND ART

Conventionally, materials in which silver is plated on a highly resilient conductive base member such as a copper alloy like phosphor bronze and beryllium copper, or a Corson copper alloy and an iron alloy like stainless steel in recent years, have been used for push switches of cellular phones, portable terminal units and the like.

In the conventional material, the conductive base member is coated with a nickel underlayer, and a silver surface layer is directly formed thereon. Meanwhile, repetitive switching operations increase due to the spread of e-mails of the cellular phones. Then, it has been known that silver is prone to be delaminated because switching parts produce heat by repeating switching in a short period of time and oxygen transmitted through the silver plating oxidizes nickel.

In order to prevent the phenomenon, there have been proposed a silver/copper/nickel/stainless material in which a copper intermediate layer is provided between a silver layer and a nickel layer (see Patent Documents 1 through 3). The copper intermediate layer is said to capture oxygen transmitted through the silver plating, thereby preventing oxidization of the underlayer nickel.

Patent Document 1: Japanese Patent No. 3889718 gazette

Patent Document 2: Japanese Patent No. 3772240 gazette

Patent Document 3: Japanese Patent Application No. 2005-133169 gazette

### DISCLOSURE OF THE INVENTION

In the electrical contact material described in Patent Documents, when the intermediate layer is too thick, copper composing the intermediate layer diffuses and appears on the outermost surface layer to be oxidized, thereby increasing a contact resistance. When the intermediate layer is too thin, the intermediate layer is unable to fully capture oxygen and the silver layer on the surface of the material is highly likely to be delaminated due to the repetitive switching operations and others. That is, it is difficult to appropriately set the thickness of the intermediate layer and that manufacturing conditions must be strictly controlled.

The present invention provides the following aspects:

(1) A silver-coated material for a movable contact component characterized in that a conductive base member composed of iron or an iron alloy is coated with an underlayer composed of nickel or a nickel alloy of 0.005 to 0.5 μm thick, the underlayer is coated with an intermediate layer composed of palladium, a palladium alloy or a silver tin alloy of 0.01 to 0.5 μm thick and the intermediate layer is coated with an outermost surface layer composed of silver or a silver alloy;
(2) The silver-coated material for a movable contact component according to the aspect (1), characterized in that the palladium alloy of the intermediate layer is gold palladium, silver palladium, tin palladium, nickel palladium or indium palladium;
(3) A silver-coated material for a movable contact component characterized in that a conductive base member composed of iron or an iron alloy is coated with an intermediate layer composed of palladium, a palladium alloy or a silver tin alloy of 0.01 to 0.5 μm thick and the intermediate layer is coated with an outermost surface layer composed of silver or a silver alloy;
(4) A method for manufacturing the silver-coated material for a movable contact component as set forth in the aspects (1) or (2), characterized in that after coating the conductive base member with the underlayer composed of nickel or the nickel alloy and implementing the activation process, the underlayer is coated with the intermediate layer and then the intermediate layer is coated with silver or the silver alloy; and
(5) A method for manufacturing the silver-coated material for a movable contact component as set forth in the aspect (3), characterized in that the conductive base member is coated with the intermediate layer and then with silver or the silver alloy after activating the conductive base member.

The abovementioned and other features and advantages of the invention will be more apparent from the following description understood by appropriately making reference to the appended drawings.

### BRIEF DESCRIPTION OF DRAWINGS

FIG. 1 is a longitudinal section view showing one mode of the invention.

FIG. 2 is a longitudinal section view showing another mode of the invention.

### BEST MODES FOR CARRYING OUT THE INVENTION

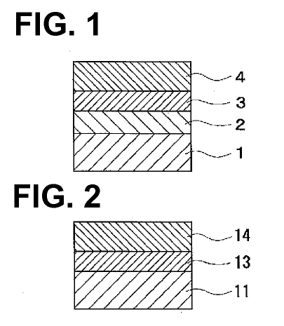

Modes for carrying out the invention will be explained below with reference to the drawings. FIG. 1 is a section view showing one mode of a silver-coated material for a movable contact component of the invention. In FIG. 1, a conductive base member 1 is composed of iron or an iron alloy, an underlayer 2 is composed of nickel or a nickel alloy, an intermediate layer 3 is composed of palladium, a palladium alloy or an Ag—Sn alloy and an outermost surface layer 4 is composed of silver or a silver alloy.

The conductive base member 1 is a material having sufficient conductivity, resilience, durability and others for use as a movable contact component and is composed or iron or an iron alloy in the present invention.

The iron alloy preferably used as the conductive base member 1 may be stainless steel (SUS), 42 alloy and others.

A thickness of the conductive base member 1 is preferable to be 0.03 to 0.3 μm and more preferable to be 0.05 to 0.1 μm.

The conductive base member 1 is coated with the underlayer 2 composed of nickel (Ni) or a Ni alloy of 0.005 to 0.5 μm, preferably of 0.01 to 0.5 μm or more preferably of 0.05 to 0.1 μm on the surface thereof. A lower limit of the thickness of the underlayer 2 is determined from an aspect of adhesion of the conductive base member 1 with the intermediate layer 3 and an upper limit of the thickness of the underlayer 2 is determined not to lower workability in forming the electrical contact material by means of pressing or the like due to the coating materials and of preventing cracks from being generated in the underlayer 2 and others.

As the Ni alloy used for the underlayer 2, such alloys as Ni—P, Ni—Sn, Ni—Co, Ni—Co—P, Ni—Cu, Ni—Cr, Ni—Zn and Ni—Fe are suitably used. Ni and the Ni alloy have favorably plating processability, have no problem in terms of cost and their barrier function deteriorate less even in a high-temperature environment because their fusion point is high.

The underlayer 2 is coated with the intermediate layer 3 composed of palladium (Pd), the palladium alloy or the silver tin alloy of 0.01 to 0.5 μm thick or more preferably 0.05 to 0.2 μm. When the palladium or the palladium alloy is used as the intermediate layer 3, its thickness is preferable to be 0.2 μm or less because palladium and the palladium alloy are hard and their workability drop and tend to cause cracks if they are thick. It is noted that a lower limit of the thickness of the intermediate layer 3 is determined from an aspect of preventing the component of the underlayer 2 from being oxidized.

All of the palladium, palladium alloy and silver tin alloy are metals or alloys that are less oxidized as compared to copper. Accordingly, as compared to one in which the copper intermediate layer is coated, they hardly cause a drop of the adhesion with silver or the silver alloy layer of the outermost surface layer 4 otherwise caused by the oxidation of the surface of the intermediate layer 3 and a drop of the conductivity (contact resistance) tends otherwise caused by the component of the intermediate layer 3 that appears on the outermost surface layer 4 and is oxidized.

The palladium alloy used for the intermediate layer 3 are preferably a gold palladium alloy (Pd—Au), a silver palladium alloy (Pd—Ag), a tin palladium alloy (Pd—Sn) and an indium palladium alloy (Pd—In).

Because palladium (Pd) is hardly diffused by alloying it, it hardly drops the adhesion with silver or a silver alloy layer and the conductivity (contact resistance) that is otherwise caused by the component of the intermediate layer 3 that appears on the outermost surface layer 4 and is oxidized.

Further, if the silver tin alloy layer is used as the intermediate layer 3, it is also hardly diffused similarly to palladium, so that it hardly drops the adhesion with the silver or silver alloy layer and the conductivity (contact resistance) that is otherwise caused by the component of the intermediate layer 3 that appears on the outermost surface layer 4 and is oxidized.

The intermediate layer 3 is coated with the outermost surface layer 4 composed of silver (Ag) or a silver alloy. The outermost surface layer 4 composed of silver (Ag) or the silver alloy is a layer provided to improve the conductivity as a contact material and its thickness is preferable to be 0.5 to 3.0 μm or more preferable to be 1.0 to 2.0 μm.

The silver alloy preferably used as the outermost surface layer 4 are two-component alloys such as a silver tin alloy, a silver nickel alloy, a silver copper alloy and a silver palladium alloy and multi-component alloys combining them.

While the underlayer 2, the intermediate layer 3 and the outermost surface layer 4 of the silver-coated material for a movable contact component described above may be coated and formed by means of plating, PVD and others, it is desirable to coat and form them by means of wet plating because it is simple and its cost is low.

The silver-coated material for a movable contact component of the mode shown in FIG. 1 may be formed through a pre-treatment of the conductive base member such as electrolytic degreasing, coating the base material with nickel or the nickel alloy by plating the nickel or the nickel alloy and after carrying out an activation treatment, coating with the intermediate layer by plating palladium, the palladium alloy or the silver tin alloy and then coating the intermediate layer with silver by plating silver or the silver alloy.

FIG. 2 is a longitudinal section view showing another mode of the silver-coated material for a movable contact component the invention. In FIG. 2, a conductive base member 11 is composed of iron or an iron alloy, an intermediate layer 13 is composed of palladium, a palladium alloy or a silver tin (Ag—Sn) alloy and an outermost surface layer 14 is composed of silver or a silver alloy. Thicknesses and preferable modes of the conductive base member 11, the intermediate layer 13 and the conductive base member 14 are the same with the conductive base member 1, the intermediate layer 3 and the outermost surface layer 4 respectively described above.

The silver-coated material for a movable contact component of the mode shown in FIG. 2 may be formed by coating with the intermediate layer by plating palladium, the palladium alloy or the silver tin alloy after activating the conductive base member without coating with nickel or the nickel alloy and then by coating with silver by plating silver or the silver alloy for example.

The invention can provide the silver-coated material for a movable contact component, and a manufacturing method of the same, whose surface silver layer will not be delaminated even if it is used in an environment in which switching is repeated, thus relaxing constraints in terms of production.

The silver-coated material for a movable contact component of the invention is suitably used for a connector, a switch, a terminal and a disk spring of an electrical contact material.

Because the metal (alloy) layer hardly oxidized is formed as the intermediate layer in the invention, it is possible to suppress the adhesion with the outermost surface layer (silver layer) from dropping that otherwise occurs due to the oxidation of the intermediate layer. Still more, because the metal (alloy) layer hardly diffused is formed in the silver layer, it is possible to suppress the drop of the conductivity and of the adhesion between the intermediate layer and the outermost surface layer that otherwise occur when the component of the intermediate layer or its oxidant and others diffuse in the outermost surface layer (silver layer). Further, because the conditions for manufacturing the intermediate layer are relaxed, it is possible to obtain an advantage that a production yield improves.

### EMBODIMENTS

While embodiments of the invention will be explained below in detail, the invention is not limited them.

### First Through 30Th Embodiments

The following treatments were carried out on strips made of SUS 301, SUS 304, SUS 403 or SUS 430 (all are stainless steel conforming to the JIS Standard) of 0.6 mm thick to obtain silver-coated materials composed of layers shown in Table 1. After that, treatments (2) through (7) in the first through eighth embodiments were carried out to obtain silver-coated materials as shown in Table 1. However, types of plating corresponding to types of the intermediate layer in Table 1 were carried out from the treatments (4) through (7). Further, types of plating in (7), (8) or (9) were carried out corresponding to the types of the outermost surface layer in Table 1.

(1) Pre-treatment: Electrolytic degreasing was carried out by cathode-electrolyzing the strip by using an aqueous solution of 100 g/l of ortho-silicate soda.

(2) Nickel Undercoat: The underlayer was formed by implementing plating under a condition of 2 A/dm² of cathode current density by using a plating solution containing 5 g/l of nickel chloride and 30% free hydrochloric acid.

(3) Activation: The treatment was carried out by holding a Cu—Be strip after plating the nickel undercoat in warm or hot water of 40 to 90° C. for more than three seconds. The temperature of the Be—Cu strip during the electrolytic degreasing to the activation process was controlled by soaking the Be—Cu strip into a washing bath whose temperature is adjusted by a cooler.

(4) Plating of Intermediate Layer (Pd): The treatment was implemented under a condition of 5 A/dm² of cathode current density by using a plating solution containing 100 g/l of palladium sulfate and 20 g/l of free hydrochloric acid.

(5) Plating of Intermediate Layer (Pd—Au, Pd—Ag): The treatment was implemented under the condition of 5 A/dm² of cathode current density by using a plating solution containing 100 g/l of palladium sulfate, 30 g/l of metallic salt of gold or silver and 20 g/l of free hydrochloric acid.

(6) Plating of Intermediate Layer (Pd—Sn, Pd—Ni, Pd—In): The treatment was implemented under the condition of 5 A/dm² of cathode current density by using a plating solution containing 100 g/l of palladium sulfate, 30 g/l of metallic salt of tin, nickel or indium and 20 g/l of free hydrochloric acid.

(7) Intermediate Layer or Outermost Surface Layer (Ag—Sn): The treatment was implemented under the condition of 5 A/dm² of cathode current density by using a plating solution containing 50 g/l of silver cyanide, 50 g/l of potassium cyanide, 30 g/l of potassium carbonate and 30 g/l of metallic salt of Sn.

(8) Outermost Surface Layer (silver striking): This treatment was implemented under a condition of 2 A/dm² of cathode current density by using a plating solution containing 5 g/l of silver cyanide and 50 g/l of potassium cyanide.

(9) Outermost Surface Layer (silver plating): This treatment was implemented under the condition of 5 A/dm² of cathode current density by using a plating solution containing 50 g/l of silver cyanide, 50 g/l of potassium cyanide and 30 g/l of potassium carbonate.

One of the treatments (4) through (7) may be carried out in plating the intermediate layer in plating the respective layers of the first through 30th embodiments. The silver striking of the treatment (8) is carried out as necessary to enhance the adhesion of the uppermost silver tin alloy in the treatment (7) or the silver plating in the treatment (9), so that the thickness was set so as to fall within 0.1 to 0.05 μm in the present embodiment. Actually, the thickness may be within a range of 0.005 to 0.1 μm. In this case, the thickness of the outermost surface layer is what the thickness of the plating in the treatment (7) or (9) described above is added to the thickness of the plating in the treatment (8).

It is noted that although the plating solution having the same components is commonly used in plating the intermediate layer and the outermost surface layer in the treatment (7), this is just one example to the end and the components may be appropriately changed within the scope in which silver is the main component. Still more, although the both intermediate layer plating and outermost surface layer plating may be silver tin plating, it is predicated on implementing the silver striking using the plating solution of the treatment (8) between them in order to adequately set the thicknesses of the both (and to prevent the intermediate layer from exceeding the upper limit in particular) in this case. Implementing the silver striking not only enhances the adhesion between the intermediate layer plating and the outermost surface layer plating but also suppresses cracks from being generated in the intermediate layer.

### First Through Fourth Comparative Examples

Silver-coated materials having layered structures shown in Table 1 were obtained in the same manner with the 9th to 22nd embodiments, except of that plating of Cu was implemented under the condition of 5 A/dm² of cathode current density by using a plating solution containing 150 g/l of copper sulfate and 100 g/l of free sulfuric acid. However, no intermediate layer plating was implemented in a third comparative example and no nickel undercoating and intermediate layer plating were implemented in a fourth comparative example.

### Test Examples

A delamination test was carried out on the respective silver-coated materials obtained from the embodiments and comparative examples within an atmosphere of 400° C. and after heating for 5 to 15 minutes to investigate the adhesion of the plating. The delamination test was carried out based on the JIS K 5600-5-6(crosscut method). Table 1 shows its results.

TABLE 1

| | | | | INTERMEDIATE | | OUTERMOST SURFACE | | | | |
|---|---|---|---|---|---|---|---|---|---|---|
| | | UNDERLAYER | | LAYER | | LAYER | | DELAMINATION | | |
| | BASE | | THICKNESS | | THICKNESS | | THICKNESS | AFTER HEATING | | |
| | MATERIAL | TYPE | (μm) | TYPE | (μm) | TYPE | (μm) | 5 min. | 10 min. | 15 min. |
| EXAMPLES | | | | | | | | | | |
| 1 | SUS301 | Ni | 0.01 | Pd | 0.01 | Ag | 1 | NIL | NIL | NIL |
| 2 | SUS301 | Ni | 0.02 | Pd | 0.1 | Ag | 1 | NIL | NIL | NIL |
| 3 | SUS301 | Ni | 0.05 | Pd | 0.3 | Ag | 1 | NIL | NIL | NIL |
| 4 | SUS301 | Ni | 0.1 | Pd | 0.1 | Ag | 1 | NIL | NIL | NIL |
| 5 | SUS301 | Ni | 0.2 | Pd | 0.2 | Ag | 1 | NIL | NIL | NIL |
| 6 | SUS301 | Ni | 0.5 | Pd | 0.3 | Ag | 1 | NIL | NIL | NIL |
| 7 | SUS301 | Ni | 0.2 | Pd—Au | 0.1 | Ag | 1 | NIL | NIL | NIL |
| 8 | SUS301 | Ni | 0.2 | Pd—Ag | 0.2 | Ag | 1 | NIL | NIL | NIL |
| 9 | SUS403 | Ni | 0.005 | Pd | 0.01 | Ag | 1 | NIL | NIL | NIL |
| 10 | SUS403 | Ni | 0.05 | Pd | 0.3 | Ag | 1 | NIL | NIL | NIL |
| 11 | SUS403 | Ni | 0.1 | Pd | 0.1 | Ag | 1 | NIL | NIL | NIL |
| 12 | SUS403 | Ni | 0.2 | Pd | 0.2 | Ag | 1 | NIL | NIL | NIL |
| 13 | SUS304 | Ni | 0.01 | Pd—Au | 0.01 | Ag | 1 | NIL | NIL | NIL |
| 14 | SUS304 | Ni | 0.1 | Pd—Ag | 0.05 | Ag | 1 | NIL | NIL | NIL |
| 15 | SUS304 | Ni | 0.05 | Pd—Ag | 0.01 | Ag | 1 | NIL | NIL | NIL |
| 16 | SUS304 | Ni | 0.05 | Pd—Ag | 0.1 | Ag | 1 | NIL | NIL | NIL |
| 17 | SUS304 | Ni | 0.05 | Pd—Sn | 0.01 | Ag | 1 | NIL | NIL | NIL |
| 18 | SUS304 | Ni | 0.05 | Pd—Ni | 0.01 | Ag | 1 | NIL | NIL | NIL |
| 19 | SUS304 | Ni | 0.05 | Pd—Sn | 0.01 | Ag | 1 | NIL | NIL | NIL |
| 20 | SUS304 | Ni | 0.01 | Ag—Sn | 0.01 | Ag | 1 | NIL | NIL | NIL |
| 21 | SUS304 | Ni | 0.01 | Ag—Sn | 0.05 | Ag | 1 | NIL | NIL | NIL |
| 22 | SUS304 | Ni | 0.05 | Ag—Sn | 0.1 | Ag | 1 | NIL | NIL | NIL |
| 23 | SUS430 | Ni | 0.05 | Pd | 0.01 | Ag—Sn | 1 | NIL | NIL | NIL |
| 24 | SUS430 | Ni | 0.1 | Pd | 0.1 | Ag—Sn | 1 | NIL | NIL | NIL |
| 25 | SUS430 | Ni | 0.05 | Pd | 0.01 | Ag | 0.5 | NIL | NIL | NIL |
| 26 | SUS430 | Ni | 0.1 | Pd | 0.1 | Ag | 2 | NIL | NIL | NIL |
| 27 | SUS430 | Ni | 0.2 | Pd | 0.05 | Ag | 0.5 | NIL | NIL | NIL |
| 28 | SUS430 | Ni | 0.05 | Pd | 0.1 | Ag | 2 | NIL | NIL | NIL |
| 29 | SUS430 | Ni | 0.05 | Pd | 0.01 | Ag | 1 | NIL | NIL | NIL |
| 30 | SUS430 | Ni | 0.005 | Pd | 0.01 | Ag | 1 | NIL | NIL | NIL |
| COMPARATIVE | | | | | | | | | | |
| EXAMPLE | | | | | | | | | | |
| 1 | SUS301 | Ni | 0.05 | Cu | 0.05 | Ag | 1 | NIL | OCCUR | OCCUR |
| 2 | SUS301 | Ni | 0.1 | Cu | 0.1 | Ag | 1 | NIL | OCCUR | OCCUR |
| 3 | SUS301 | Ni | 0.1 | NIL | NIL | Ag | 1 | NIL | OCCUR | OCCUR |
| 4 | SUS301 | NIL | NIL | NIL | NIL | Ag | 1 | OCCUR | OCCUR | OCCUR |

As shown in Table 1, delamination occurred in all of the first through fourth comparative examples after 10 minutes and delamination occurred after five minutes in the fourth comparative example in particular.

However, no delamination occurred in any of the first through 30th embodiments after 15 minutes, showing excellent delamination resistance of the outermost surface layer.

Thus, it can be seen that the production yield of the silver-coated material for a movable contact component of the invention has been improved because the silver-coated material for a movable contact component of the invention (1) suppresses the adhesion of the silver layer from dropping that otherwise occurs due to the oxidation of the intermediate layer; (2) suppresses the drop of the conductivity (increase of contact resistance) that otherwise occurs due to the component of the intermediate layer or its oxidants diffusing in the silver layer and the drop of the adhesion between the intermediate layer and the outermost surface layer; and (3) relaxes the manufacturing condition of the intermediate layer.

### INDUSTRIAL APPLICABILITY

The silver-coated material for a movable contact component of the invention may be suitably used for a connector, a switch, a terminal and a disk spring member of an electrical contact material.

While the invention has been described with its modes, the inventors have no intention of limiting any detail of the explanation of the invention unless specifically specified and consider that the invention should be construed widely without going against the spirit and scope of the invention indicated by the scope of the appended Claims.

This application claims priority from Japanese patent application Nos. 2007-082604 filed on Mar. 27, 2007 and 2008-076885 filed on Mar. 24, 2008. The entire content of which is incorporated herein by reference.

1. A silver-coated material for a movable contact component, comprising:
a conductive base member formed of iron or iron alloy;
an underlayer coating the conductive base member, said underlayer being formed of nickel or a nickel alloy and having a thickness of 0.005 to 0.5 μm;
an intermediate layer covering the underlayer, said intermediate layer being formed of palladium, a palladium alloy or a silver tin alloy and having a thickness of 0.01 to 0.5 μm; and
an outermost surface layer covering the intermediate layer and formed of silver or a silver alloy.

2. The silver-coated material for a movable contact component according to claim 1, wherein said intermediate layer is formed of the palladium alloy including gold palladium, silver palladium, tin palladium, nickel palladium or indium palladium.

3. A silver-coated material for a movable contact component, comprising:
a conductive base member formed of iron or iron alloy;
an intermediate layer covering the conductive base member, said intermediate layer being formed of palladium, a palladium
alloy or a silver tin alloy and having a thickness of 0.01 to 0.5 μm thick; and
an outermost surface layer covering the intermediate layer and formed of silver or a silver alloy.

4. A method for manufacturing the silver-coated material for a movable contact component according to claim 1, comprising the steps of:
coating nickel or the nickel alloy on the conductive base member;
conducting an activation process on the conductive base member;
coating the intermediate layer; and
coating silver or the silver alloy.

5. A method for manufacturing the silver-coated material for a movable contact component set according to claim 3, comprising the steps of:
conducting an activation process on the conductive base member;
coating the intermediate layer; and
coating silver or the silver alloy.
